(19) United States
(12) Patent Application Publication
(10) Pub. No.: US 2022/0155995 A1
(43) Pub. Date: May 19, 2022

(54) CONTROLLER AND OPERATING METHOD THEREOF

(71) Applicant: SK hynix Inc., Gyeonggi-do (KR)

(72) Inventor: Sang Hune JUNG, Gyeonggi-do (KR)

(21) Appl. No.: 17/336,633

(22) Filed: Jun. 2, 2021

(30) Foreign Application Priority Data
Nov. 18, 2020 (KR) 10-2020-0154396

(51) Int. Cl. G06F 3/06; G06F 12/02; G06F 12/06

(52) U.S. Cl. CPC G06F 3/0656; G06F 3/0659; G06F 3/0604; G06F 2212/7201; G06F 12/0238; G06F 12/0607; G06F 3/0679

(57) ABSTRACT

A controller that controls a memory device, the controller includes: a processor configured to detect at least one sequential read request group with consecutive logical addresses among a predetermined number of host read requests, regardless of whether sequential read requests included in the sequential read request group are successively received, predict a logical addresses for the detected group of sequential read requests, to control the memory device to prepare a data chunk associated with the predicted logical addresses; and a memory configured to buffer the prepared data chunk, wherein the processor is further configure to provide the buffered data chunk to a host when a request for the predicted data chunk is received from the host.

### CROSS-REFERENCE TO RELATED APPLICATION

This application claims priority under 35 U.S.C. § 119 to Korean Patent Application No. 10-2020-0154396 filed on Nov. 18, 2020, which is incorporated herein by reference in its entirety.

### BACKGROUND

### 1. Field

Various embodiments relate to a controller that controls a memory device.

### 2. Discussion of the Related Art

The computer environment paradigm has been transitioning to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Since they have no moving parts, memory systems provide advantages such as excellent stability and durability, high information access speed, and low power consumption. Examples of memory systems having such advantages include universal serial bus (USB) memory devices, memory cards having various interfaces, and solid state drives (SSD).

### SUMMARY

Various embodiments are directed to providing a controller capable of improving an operating speed of a memory system by more effectively performing a predictive read operation in a multi-stream environment, and an operation method thereof.

In accordance with an embodiment, a controller that controls a memory device, the controller includes: a processor configured to: detect at least one sequential read request group corresponding to consecutive logical addresses among a predetermined number of host read requests, regardless of whether sequential read requests included in the sequential read request group are successively received, predict a logical addresses for the detected group of sequential read requests, and control the memory device to prepare a data chunk associated with the predicted logical addresses; and a memory configured to buffer the prepared data chunk, wherein the processor is further configured to provide the buffered data chunk to a host when a request for the predicted data chunk is received from the host.

The processor may predict the logical addresses which is consecutive to the consecutive addresses.

The at least one sequential read request group may be read requests, each of which have the same data length and which are consecutive by a predetermine length or more, among the host read requests.

The processor may detect the at least one data stream by detecting sequential read request groups with a data length equal to or more than a threshold value among the host data chunks associated with host read requests, and detecting sequential read request groups corresponding to logical addresses consecutive to each other among the host read requests.

The processor may assign a stream ID to each the detected sequential read request group.

The logical addresses may be used in the host, and wherein the processor controls the memory device to prepare the data chunk associated with the logical addresses by: generating a predictive read request corresponding to the logical addresses, translating logical addresses of the predictive read request and a preceding read request preceding to the predictive read request into physical addresses associated with the memory device, and generating a predictive read command corresponding to the predictive read request and a preceding read command corresponding to the preceding read request based on the physical addresses.

When the physical addresses may indicate the same memory die, the processor generates cache read commands as the predictive read command and the preceding read command.

The processor may provide the buffered data chunk to the host by: buffering, in the memory, the data chunk prepared in a page buffer of the memory device in response to the predictive read command, and providing the buffered data chunk to the host in response to the request for the buffered data chunk.

When the physical addresses indicate different memory dies, the processor may generate normal read commands as the predictive read command and the preceding read command, and interleave the generated normal read commands.

The processor may provide the buffered data chunk to the host by: buffering, in the memory, the data chunk prepared in response to the predictive read command, and providing the buffered data chunk to the host in response to the request for the prepared data chunk.

In accordance with an embodiment, an operation method of a controller that controls a memory device, the operation method includes: detecting at least one sequential read request group corresponding to consecutive logical addresses among a predetermined number of host read requests, regardless of whether sequential read requests included in the sequential read request group are successively received; predicting a logical addresses for the detected group of sequential read requests; controlling the memory device to prepare a data chunk associated with the predicted logical addresses; and providing the prepared data chunk to the host when a request for the predicted data chunk is received from the host.

The predicting of the logical addresses for the detected group of sequential read requests comprises predicting the logical addresses which is consecutive to the consecutive addresses.

The at least sequential read request group may be read requests, each of which has the same data length and which are consecutive by a predetermine length or more, among the host read requests.

The detecting of the at least one data stream includes: detecting sequential read request groups with a data length equal to or more than a threshold value among the host read requests; and detecting sequential read request groups corresponding to logical addresses consecutive to each other among the host read requests.

The operation method may further include: assigning a stream ID to the detected sequential read request group.

The logical addresses are used in the host, and the controlling of the memory device to prepare the data chunk associated with the logical addresses may include: generating a predictive read request corresponding to the logical addresses; translating logical addresses of the predictive read request and a preceding read request preceding to the predictive read request into physical addresses associated with the memory device; and generating a predictive read command corresponding to the predictive read request and a preceding read command corresponding to the preceding read request based on the physical addresses.

The generating of the predictive read command and the preceding read command may include: generating cache read commands as the predictive read command and the preceding read command when the physical addresses indicate the same memory die.

The providing of the prepared data chunk to the host may include: buffering, in a memory of the controller, the data chunk prepared in a page buffer of the memory device in response to the predictive read command; and providing the buffered data chunk to the host in response to the request for the prepared data chunk.

The generating of the predictive read command and the preceding read command includes: generating normal read commands as the predictive read command and the preceding read command when the physical addresses indicate different memory dies; and interleaving the generated normal read commands.

The providing of the prepared data chunk to the host may include: buffering, in a memory of the controller, the data chunk prepared in response to the predictive read command; and providing the buffered data chunk to the host in response to the request for the prepared data chunk.

In accordance with an embodiment, an operating method of a controller, the operating method includes: receiving a predetermined number of read requests together with corresponding addresses; predicting an address consecutively subsequent to a predetermined number of consecutive addresses, which are from among the received addresses; obtaining data corresponding to the predicted address from a memory device during a read operation of the memory device according to the consecutive addresses; and providing the obtained data in response to a subsequent read request provided together with the predicted address without a read operation of the memory device for the subsequent read request.

An embodiment the present disclosure provides a controller capable of improving an operating speed of a memory system by more effectively performing a predictive read operation in a multi-stream environment, and an operation method thereof.

### BRIEF DESCRIPTION OF THE DRAWINGS

FIG. 1 is a diagram for illustrating an example of a data processing system including a controller in accordance with an embodiment of the present disclosure.

FIG. 2 is a diagram illustrating a controller, such as that of FIG. 1.

FIG. 3 is a diagram illustrating a configuration of a DIE in a memory device, according to an embodiment.

FIG. 4 is a diagram for illustrating a predictive read operation.

FIG. 5 is a diagram for illustrating read command reception in a multi-stream environment.

FIG. 6 is a diagram for illustrating an operation of the controller in accordance with the embodiment of the present disclosure.

FIG. 7A and FIG. 7B are diagrams for illustrating a read operation of the memory die.

FIG. 8 is a timing diagram when a predictive read operation and a preceding host read operation are performed using cache read commands.

FIG. 9 is a timing diagram when the predictive read operation and the preceding host read operation are performed using interleaved normal read commands.

FIG. 10 is a flowchart describing an operation of the controller in accordance with the embodiment of the present disclosure.

### DETAILED DESCRIPTION

Hereinafter, various embodiment of the present disclosure will be described with reference to the accompanying drawings. However, the present disclosure is not limited to the embodiments disclosed below, but may be configured in various different forms. The present embodiment is provided to bring the disclosure of the present disclosure to perfection and assist those skilled in the art to completely understand the scope of the present disclosure.

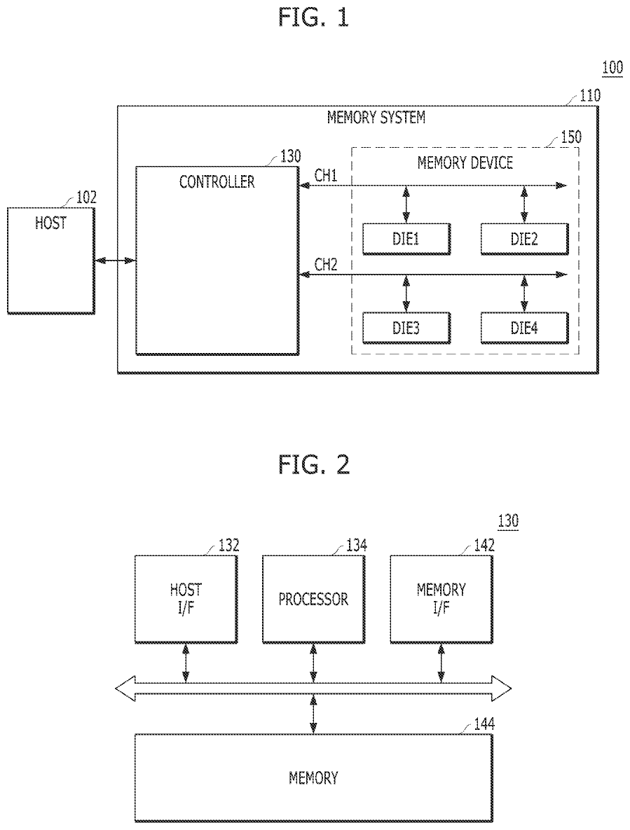

FIG. 1 is a block diagram illustrating a data processing system 100 including a controller 130 in accordance with an embodiment of the present invention.

Referring to FIG. 1, the data processing system 100 may include a host 102 operatively coupled to a memory system 110.

The host 102 may include any of various portable electronic devices such as a mobile phone, MP3 player and laptop computer, or any of various non-portable electronic devices such as a desktop computer, a game machine, a television (TV), and a projector.

The host 102 may include at least one operating system (OS), which may manage and control overall functions and operations of the host 102, and provide operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user.

The memory system 110 may operate to store data for the host 102 in response to a request of the host 102. Non-limiting examples of the memory system 110 may include a solid state drive (SSD), a multi-media card (MMC), a secure digital (SD) card, a universal serial bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the like. The SD card may include a mini-SD card and micro-SD card.

The memory system 110 may be embodied by various types of storage devices. Examples of such storage devices may include, but are not limited to, volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory. The flash memory may have a 3-dimensional (3D) stack structure.

The memory system 110 may include the controller 130 and a memory device 150. The memory device 150 may store data for the host 102, and the controller 130 may control data storage into the memory device 150.

The controller 130 and the memory device 150 may be integrated into a single semiconductor device. For example, the controller 130 and the memory device 150 may be integrated as one semiconductor device to constitute a solid state drive (SSD). When the memory system 110 is used as an SSD, the operating speed of the host 102 connected to the memory system 110 can be improved. In addition, the controller 130 and the memory device 150 may be integrated as one semiconductor device to constitute a memory card. For example, the controller 130 and the memory device 150 may constitute a memory card such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD card, micro-SD card and SDHC card, or universal flash storage (UFS) device.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a flash memory device. The flash memory device may store data in a memory cell array composed of memory cell transistors. The flash memory device may have a hierarchical structure composed of a memory die, a memory block, and a page. FIG. 1 illustrates the first to fourth memory dies DIE1 to DIE4 connected to the controller 130 through the first and second channels CH1 and CH2.

The flash memory device may include a plurality of memory dies. One memory die may include a plurality of memory blocks. The memory block may be a minimum unit of an erase operation. One memory block may include a plurality of pages. The page may be a minimum unit of a write operation.

One DIE may receive one command at a time through the channel connected to the controller 130. The memory dies having received the command may operate in parallel.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, program and erase operations of the memory device 150.

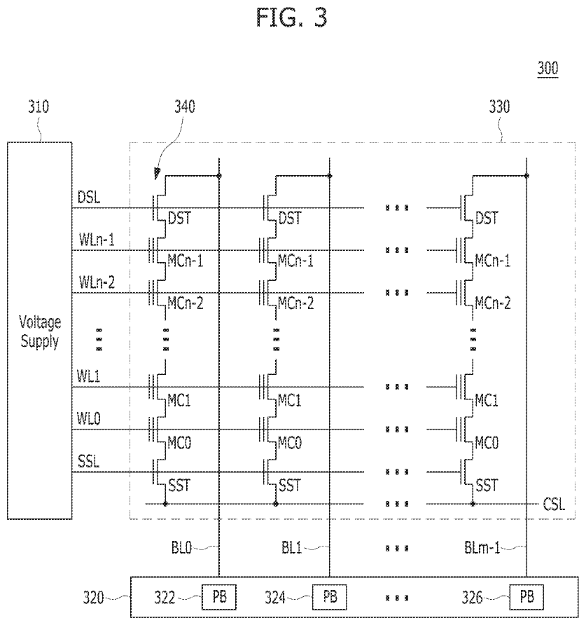

The controller 130 and the memory device 150 will be described in more detail with reference to FIG. 2 and FIG. 3.

FIG. 2 is a diagram for illustrating a controller, such as the controller 130 of FIG. 1.

The controller 130 may include a host interface (I/F) 132, a processor 134, a memory I/F 142, and a memory 144 all operatively coupled via an internal bus.

The host I/F 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE).

The host I/F 132 may be driven through firmware referred to as a host interface layer (HIL) in order to exchange data with the host.

The memory I/F 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory I/F 142 may generate a control signal for the memory device 150 and process data to be provided to the memory device 150 under the control of the processor 134. The memory I/F 142 may work as an interface (e.g., a NAND flash interface) for processing a command and data between the controller 130 and the memory device 150. In an embodiment, the memory I/F 142 may support data transfer between the controller 130 and the memory device 150.

The memory I/F 142 may be driven through firmware referred to as a flash interface layer (FIL) in order to exchange data with the memory device 150.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor or a central processing unit (CPU).

The processor 134 may drive the FTL and perform a foreground operation corresponding to a request received from the host. For example, the processor 134 may control a write operation of the memory device 150 in response to a write request from the host and control a read operation of the memory device 150 in response to a read request from the host.

Also, the controller 130 may perform a background operation onto the memory device 150 through the processor 134, which is realized as a microprocessor or a CPU. For example, the background operation performed onto the memory device 150 may include a garbage collection (GC) operation, a wear-leveling (WL) operation, a map flush operation, or a bad block management operation.

The memory 144 may serve as a working memory of the memory system 110 and the controller 130, and store data for driving the memory system 110 and the controller 130. The controller 130 may control the memory device 150 to perform read, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

As described above, the memory 144 may store data required for performing a data write/read operation between the host and the memory device 150 and data when the data write/read operation is performed. In order to store such data, the memory 144 may include a program memory, data memory, write buffer/cache, read buffer/cache, data buffer/cache, map buffer/cache or the like.

FIG. 3 is a diagram illustrating a configuration of a memory die 300 in the memory device 150, according to an embodiment.

The memory die 300 may correspond to the first to fourth dies DIE1 to DIE4 described with reference to FIG. 1. The memory die 300 may include a memory cell array 330 including a plurality of memory cells. The memory cell array 330 may include a plurality of memory blocks.

Referring to FIG. 3, the memory cell array 330 of the memory system 110, may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST and SST, a plurality of memory cells or memory cell transistors MC0 to MCn-1 may be coupled in series. In an embodiment, each of the memory cells MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1. For reference, in FIG. 3, ‘DSL’ denotes a drain select line, ‘SSL’ denotes a source select line, and ‘CSL’ denotes a common source line.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory die 300 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory die 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

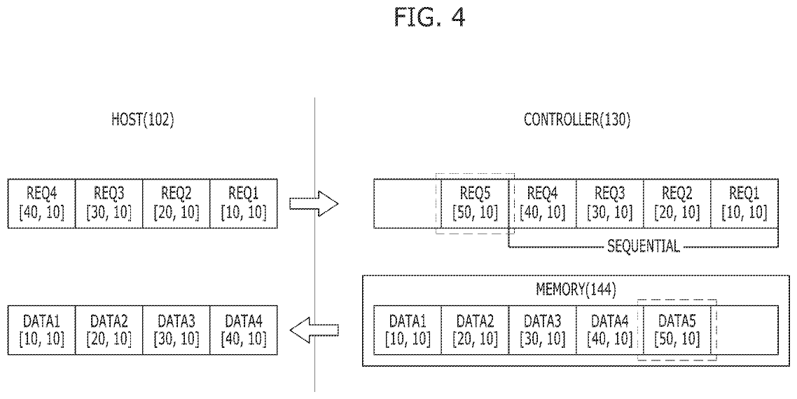

FIG. 4 is a diagram for illustrating a predictive read operation.

FIG. 4 illustrates a request and data exchanged between the host 102 and the controller 130.

The host 102 may request a data stream from the controller 130. The data stream may refer to a series of data corresponding to consecutive addresses. In order to request the data stream from the controller 130, the host 102 may divide the data stream into data chunks having a predetermined or set size with respect to an address of data, and generate a plurality of read requests for reading the data chunks. The host 102 may provide the controller 130 with the plurality of read requests associated with the data stream. For example, the host 102 may provide the controller 130 with first to fourth requests REQ1 to REQ4 which are read requests.

Each of the read requests provided from the host 102 to the controller 130 may include address information of a data chunk to be read. In the drawing figures, the address information included in each request is expressed in the format of [start address, data length]. Data length information may indicate the length of a corresponding data chunk from the start address. For example, the address information [20, 10] of the second request REQ2 may indicate 10 addresses consecutive from address ‘20’. Meanwhile, the embodiment of the present disclosure will be described using an example in which the data length information is expressed as information on the number of consecutive addresses; however, a method of expressing the data length information is not limited thereto.

The first to fourth requests REQ1 to REQ4 are read requests associated with data chunks corresponding to 40 addresses consecutive from address ‘10’ and may be read requests associated with one data stream. A plurality of read requests for one data stream may be referred to as a group of sequential read requests for the data stream.

Based on address information of a plurality of data chunks associated with a plurality of read requests received from the host 102 through the host I/F 132, the processor 134 may determine whether the plurality of read requests are sequential read requests and the plurality of data chunks configures one data stream. For example, when the addresses of the plurality of data chunks are consecutive by a predetermined number, the processor 134 may determine that the data chunks corresponding to the consecutive addresses configures one data stream. In the example of FIG. 4, based on the address information of the first to fourth requests REQ1 to REQ4, the processor 134 may determine that the data chunks corresponding to the 40 consecutive addresses configures one data stream and determine the first to fourth requests REQ1 to REQ4 as a group of sequential read requests for the data stream.

When currently received requests are determined as a group of sequential read requests, the processor 134 may predict that a subsequent read request associated with the data stream will be further received from the host 102 in the future, and generate a predictive read request in advance before the host 102 actually provides the subsequent read request. For example, when the host 102 requests data chunks from addresses ‘10’ to ‘49’, the processor 134 may predict that the host 102 will further request a data chunk from address ‘50’ consecutive to the data chunks from addresses ‘10’ to ‘49’. Even before the host 102 actually requests the data chunk from the address ‘50’, the processor 134 may generate a fifth request REQ5 that is a predictive read request for the data chunk having 10 addresses consecutive from the address ‘50’. The processor 134 may control the memory device 150 to perform a read operation in response to the first to fifth requests REQ1 to REQ5.

An operation, in which the processor 134 detects a sequential read request group corresponding to consecutive addresses to predict addresses and controls the memory device 150 to prepare the predicted addresses in advance by generating the predictive read request, may be referred to as a predictive read operation.

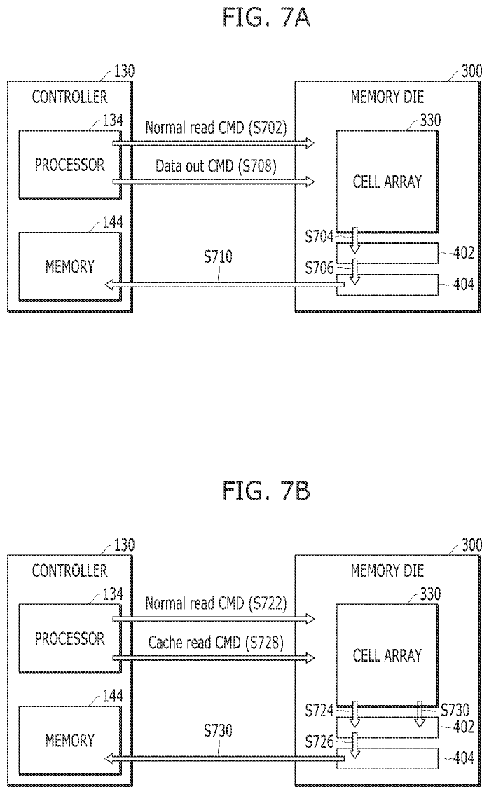

In response to the first to fifth requests REQ1 to REQ5, the memory device 150 may not only buffer first to fourth data chunks DATA1 to DATA4 in the memory 144 but also prepare a fifth data chunk DATA5, i.e., the predicted data chunk, in the memory 144 in advance. In the drawing figures, address information corresponding to each data chunk is expressed in the format of [start address, data length]. Preparing the predicted data chunk by the memory device 150 may refer to latching the predicted data chunk in an internal page buffer or buffering the predicted data chunk in the memory 144. An operation in which the memory device 150 prepares the predicted data chunk will be described with reference to FIG. 7A and FIG. 7B.

The host I/F 132 may provide the host 102 with the first to fourth data chunks DATA1 to DATA4 requested by the host 102. Then, when a request for the fifth data chunk DATA5 is received from the host 102, the processor 134 may provide the fifth data chunk DATA5 buffered in the memory 144 to the host 102 through the host I/F 132 without any further read operation of the memory device 150 for the fifth data chunk DATA5.

The processor 134 may generate a predictive read command, which is a read command for preparing a predicted data chunk, which is predicted to be requested by the host 102, and control the memory device 150 to obtain or buffer the predicted data chunk as a prepared data chunk in the memory 144 by using the predictive read command. When an actual request for the prepared data chunk is received from the host 102, the processor 134 may directly provide a prepared data chunk to the host 102, thereby improving the read operation performance of the memory system 110.

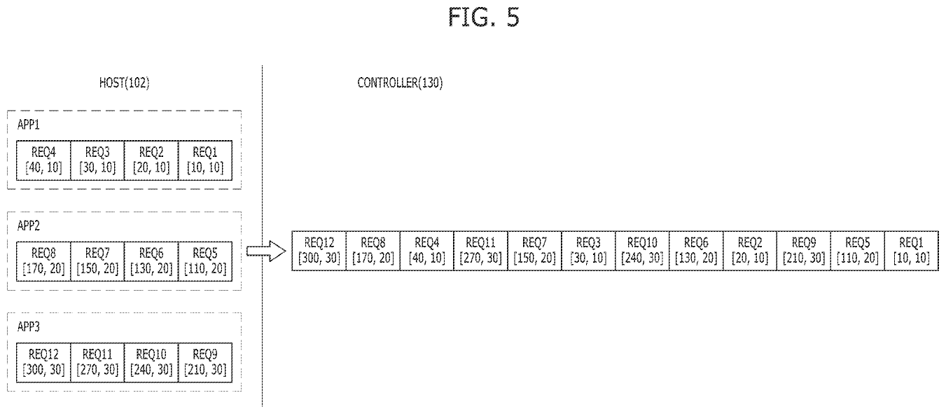

FIG. 5 is a diagram for explaining read request reception in a multi-stream environment.

The host 102 may execute a plurality of applications APP1 to APP3. The plurality of applications APP1 to APP3 may request different data streams from the controller 130, respectively. Each of the plurality of applications APP1 to APP3 may divide a data stream into data chunks having a predetermined size with respect to an address of data, and generate a plurality of read requests for the data chunks. The host 102 may provide the controller 130 with the plurality of read requests generated by each of the plurality of applications APP1 to APP3.

FIG. 5 illustrates the first to fourth requests REQ1 to REQ4, which are read requests generated by the first application APP1, fifth to eighth requests REQ5 to REQ8, which are read requests generated by the second application APP2, and ninth to twelfth requests REQ9 to REQ12 which are read requests generated by the third application APP3. In the example of FIG. 5, according to address information of data chunks associated with the first to twelfth requests REQ1 to REQ12, addresses of data chunks requested by the same application may be consecutive to one another, but addresses of data chunks requested by different applications may not be consecutive to one another.

When the controller 130 detects at least one sequential read request group corresponding to consecutive addresses based on requests received from the host 102 and processes the requests by classifying the requests for each sequential read request group, the performance and life of the memory system 110 may be improved. For example, when the controller 130 may generate a predictive read request for each data stream and prepare predicted data chunks for each sequential read request group, the read operation performance of the memory system 110 may be improved.

Sequential read requests generated by different applications may be received by the controller 130 in a mixed manner. FIG. 5 illustrates a case where the first to twelfth requests REQ1 to REQ12 are received by the controller 130 in a mixed manner. In the example of FIG. 5, addresses of data chunks associated with consecutively received requests may not be consecutive.

When providing the request to the controller 130, the host 102 may not provide the stream ID. Even through the host 102 does not provide the stream ID to the controller 130, the processor 134 is required to detect at least one sequential read request group based on read requests received in a mixed manner and to generate a predictive read request for each sequential read request group.

In accordance with the embodiment of the present disclosure, the processor 134 may detect at least one sequential read request group based on address information of data chunks associated with read requests from the host 102. For example, when a predetermined number of consecutive addresses are detected, the processor 134 may determine that a sequential read request group associated with a data stream is received from the host 102.

The processor 134 may generate a predictive read request for each detected sequential read request group. For example, the controller 130 may assign different stream IDs to the detected sequential read request group. The processor 134 may predict addresses, which may be requested by the host 102 in the future, for each data stream. Then, the processor 134 may generate a predictive read request for preparing the predicted addresses corresponding to each stream ID. Based on the predictive read request for each stream ID, the processor 134 may control the memory device 150 to prepare the predicted addresses. When an actual request for the predicted addresses is received from the host 102, the processor 134 may provide the prepared data chunk to the host 102.

In accordance with an embodiment of the present disclosure, even though the host 102 does not provide a stream ID to the controller 130, the processor 134 may detect a sequential read request group from address information of read requests and generate a predictive read request for each data stream. Even though addresses included in requests sequentially received by the controller 130 are not consecutive, the processor 134 may generate a predictive read request for each data stream by detecting at least one sequential read request group, thereby improving the read operation performance of the memory system 110.

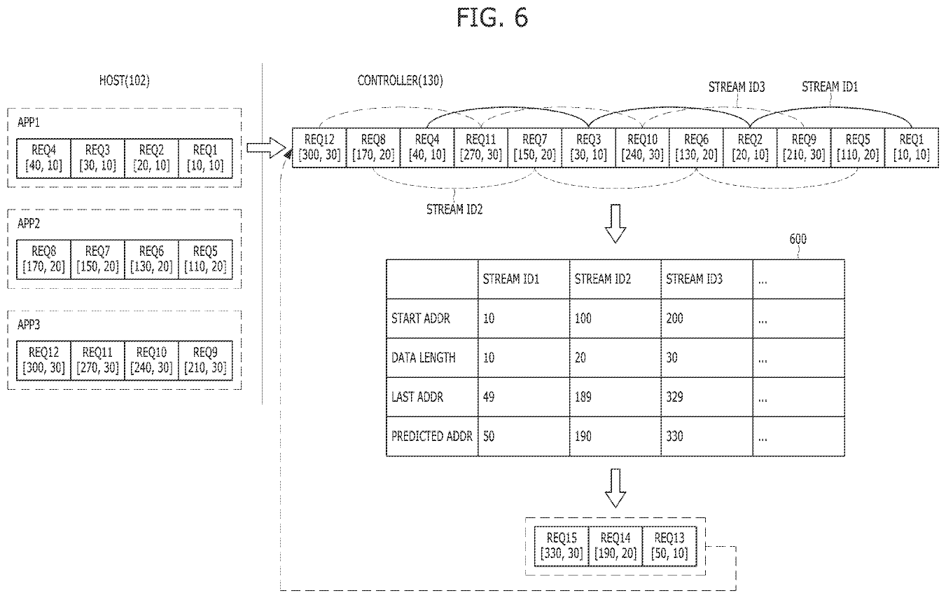

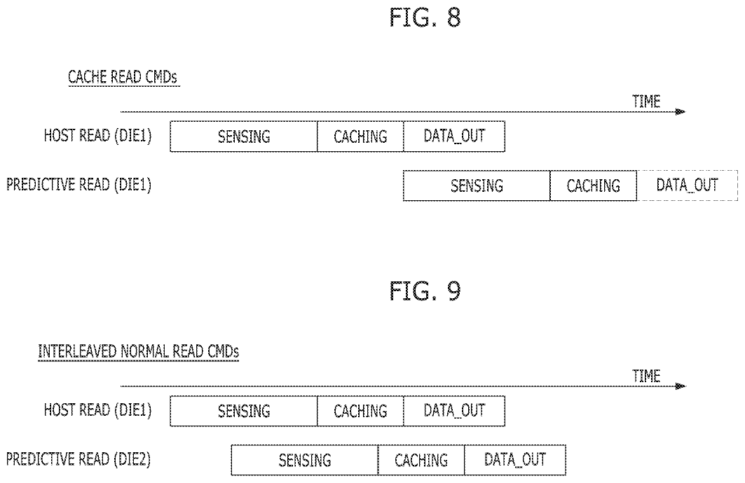

An operation of the controller 130 in accordance with the embodiment of the present disclosure will be described in detail with reference to FIG. 6, FIG. 7A and FIG. 7B, FIG. 8, and FIG. 9.

FIG. 6 is a diagram for illustrating an operation of the controller 130 in accordance with the embodiment of the present disclosure.

In a multi-stream environment, the host 102 may provide the controller 130 with a plurality of sequential read requests generated by the plurality of applications APP1 to APP3, respectively. The sequential read requests generated by the plurality of applications APP1 to APP3 may be received by the controller 130 in a mixed manner. FIG. 6 illustrates a case where the first to twelfth requests REQ1 to REQ12 generated by the plurality of applications APP1 to APP3 are received in a mixed manner, so that addresses of sequentially received requests are not consecutive to one another.

The processor 134 may collect address information of read requests recently received from the host 102 and detect a sequential read request group associated with a data stream based on the collected address information. Depending on implementation, the processor 134 may collect only address information of read requests for reading data chunks having a predetermined size or more. For example, the processor 134 may collect only address information of read requests in which a data length requested by each of the read requests is equal to more than a threshold value. In the example of FIG. 6, the processor 134 may collect address information of read requests in which a data length requested by each of the read requests is equal to or more than ‘10’ and detect a data stream based on the collected address information.

In the example of FIG. 6, the processor 134 may collect the address information of the first to twelfth requests REQ1 to REQ12 received from the host 102. Based on the collected address information, the processor 134 may detect at least one sequential read request group by detecting a predetermined number or more of consecutive addresses having the same data length. Then, the processor 134 may assign a stream ID to the detected sequential read request group.

In an example, in which the processor 134 detects a sequential read request group by detecting 40 or more consecutive addresses, the processor 134 may detect a sequential read request group based on the first to fourth requests REQ1 to REQ4, each of which has a data length of ‘10’ and whose 40 addresses are consecutive and assign stream ID ‘1’ to the sequential read request group. Likewise, the processor 134 may assign stream ID ‘2’ to a sequential read request group including the fifth to eighth requests REQ5 to REQ8, each of which has a data length of ‘20’ and whose 80 addresses are consecutive. The processor 134 may assign stream ID ‘3’ to a sequential read request group including the ninth to twelfth requests REQ9 to REQ12, each of which has a data length of ‘30’ and whose 120 addresses are consecutive.

The processor 134 may generate a stream table 600 that stores information on the sequential read request groups associated with data streams to which the stream IDs are assigned. The stream table 600 may be stored in the memory 144. The stream table 600 may include, for each stream ID, a start address (“START ADDR”), a data length requested by each read request (“DATA LENGTH”), a last address (“LAST ADDR”), and predicted address information (“PREDICTED ADDR”) of data chunks included in the data streams.

The processor 134 may refer to the collected address information and update the start address, the data length requested by each read request, and the last address of the data chunks for each stream ID in the stream table 600. For example, data chunks associated with the first to fourth requests REQ1 to REQ4 are sequential data chunks and may correspond to the stream ID ‘1’. For the stream ID ‘1’, the processor 134 may determine the start address as ‘10’, the data length requested by each read request as ‘10’, and the last address as ‘49’ by referring to the address information of the first to fourth requests REQ1 to REQ4 and update the stream table 600. Likewise, for the stream ID ‘2’, the processor 134 may determine the start address as ‘100’, the data length requested by each read request as ‘20’, and the last address as ‘189’ by referring to the address information of the fifth to eighth requests REQ5 to REQ8, and update the stream table 600. For the stream ID ‘3’, the processor 134 may determine the start address as ‘200’, the data length requested by each read request as ‘30’, and the last address as ‘329’ by referring to the address information of the ninth to twelfth requests REQ9 to REQ12, and update the stream table 600.

The processor 134 may predict an address of a subsequent data chunk to be requested by the host 102 for each stream ID, based on the start address, the data length requested by each read request, and the last address for each stream ID, and update the predicted address information in the stream table 600. For example, the processor 134 may predict an address of a subsequent data chunk to be requested by the host 102 as ‘50’ based on the last address ‘49’ of the stream ID ‘1’ in the stream table 600 and update the predicted address of the stream ID ‘1’ in the stream table 600. Likewise, also for the stream ID ‘2’ and the stream ID ‘3’, the processor 134 may predict addresses of subsequent data chunks to be requested as ‘190’ and ‘330’ based on the last address ‘189’ and ‘329’, respectively, and update the stream table 600.

The processor 134 may generate a predictive read request based on the data length requested by each read request and the predicted address of the stream table 600. For example, based on the predicted address ‘50’ and the data length ‘10’ requested by each read request of the stream ID ‘1’, the processor 134 may generate a thirteenth request REQ13 which is a predictive read request for a subsequent data chunk having 10 addresses consecutive from address ‘50’. Likewise, based on the data length requested by each read request and the predicted address of the stream ID ‘2’, the processor 134 may generate a fourteenth request REQ14 which is a predictive read request for a subsequent data chunk having 20 addresses consecutive from address ‘190’, and based on the data length requested by each read request and the predicted address of the stream ID ‘3’, the processor 134 may generate a fifteenth request REQ15 which is a predictive read request for a subsequent data chunk having 30 addresses consecutive from address ‘330’.

The processor 134 may control the memory device 150 based on the thirteenth to fifteenth requests REQ13 to REQ15. In response to the thirteenth to fifteenth requests REQ13 to REQ15, the memory device 150 may prepare the subsequent data chunks predicted to be requested by the host 102 for each stream ID. When the predicted data chunks are actually requested by the host 102, the processor 134 may immediately provide the prepared data chunks to the host 102 without reading data from the memory device 150.

Depending on implementation, when the predicted data chunks are actually requested by the host 102, the processor 134 may predict that next data chunks consecutive to the predicted data chunks may be further requested by the host 102. Based on the address information of the predicted data chunks, the processor 134 may update the last address of the stream table 600, and newly predict an address of the next data chunk predicted to be requested by the host 102. The processor 134 may generate a next predictive read request based on the newly predicted address.

Meanwhile, in order to process the host read request and the predictive read request, the processor 134 may generate read commands to be provided to the memory device 150. The processor 134 may selectively generate cache read commands and normal read commands corresponding to the host read request and the predictive read request. Then, the processor 134 may selectively interleave the normal read commands corresponding to the host read request and the predictive read request. When the memory device 150 executes the cache read commands or executes the interleaved normal read commands, the predictive read operation performance of the memory system 110 may be further improved than when the memory device 150 executes a non-interleaved normal read command.

The normal read command and the cache read command will be described with reference to FIG. 7A and FIG. 7B.

FIG. 7A and FIG. 7B illustrate a controller, such as the controller 130 of FIG. 1, and a memory die, such as the memory die 300 of FIG. 3.

FIG. 7A and FIG. 7B illustrate one memory cell array cell array 330 included in the memory die 300 and latch groups 402 and 404 connected to the cell array 330. As described with reference to FIG. 3, the memory die 300 may include a plurality of page buffers and each of the page buffers may include a plurality of latches. For example, each of the page buffers may include a sensing latch and a cache latch.

The sensing latch may sense a current flowing from a bit line during a read operation and latch data of a memory cell to be read, based on the sensing result. The cache latch may latch data, latched in the sensing latch, during the read operation and output the latched data to the controller 130. FIG. 7A and FIG. 7B illustrate the sensing latch group 402 including a plurality of sensing latches connected to a plurality of bit lines associated with the cell array 330, and the caching latch group 404 including a plurality of cache latches connected to the plurality of sensing latches.

The processor 134 may provide a normal read command and a cache read command to the memory device 150.

A normal read command operation of the memory device 150 will be described with reference to FIG. 7A.

In operation S702, the processor 134 may provide the normal read command to the memory device 150 through the memory I/F 142.

Meanwhile, a memory area of the memory device 150 may be identified by an address different from that used in the host 102. The host read request and the predictive read request may include logical address information used in the host 102. For example, the logical address may be a logical block address (LBA) used in a file system of an operating system of the host 102. The processor 134 may translate logical address information of a read request into physical address information, and provide a read command including the physical address information to any one of the memory dies of the memory device 150.

In operation S704, the memory die 300 may perform a sensing operation in response to the normal read command.

For example, the memory die 300 may sense a current flowing from the bit lines, by applying a read voltage to word lines associated with memory cells indicated by the physical address in the cell array 330, and latch data of a memory cell to be read in the sensing latch group 402 based on the sensing result.

In operation S706, the memory die 300 may perform a caching operation of the sensed data.

For example, the memory die 300 may latch the data, which has been latched in the sensing latch group 402, in the caching latch group 404.

In operation S708, the processor 134 may provide the data output command to the memory device 150 through the memory I/F 142.

In operation S710, the memory die 300 may perform a data output operation of outputting the data latched in the cache latch to the memory 144 of the controller 130.

A cache read command operation of the memory device 150 will be described with reference to FIG. 7B.

In operation S722, the processor 134 may provide a normal read command to the memory device 150 through the memory I/F 142.

In operation S724, the memory die 300 may perform a sensing operation on first data corresponding to the normal read command.

For example, the memory die 300 may sense a current flowing from the bit lines, by applying the read voltage to the word lines of the cell array 330, and latch the first data in the sensing latch group 402 based on the sensing result.

In operation S726, the memory die 300 may perform a caching operation of the first data. The caching operation has been described with reference to operation S706 of FIG. 7B.

As a result of translating the logical address information of the read request into the physical address information, when a subsequent read request needs to be processed in the same memory die, the processor 134 may generate a cache read command based on the subsequent read request.

In operation S728, the processor 134 may provide the cache read command to the memory device 150 through the memory I/F 142.

In operation S730, the memory die 300 may output the first data latched in the caching latch group to the memory 144 in response to the cache read command, and simultaneously perform a sensing operation on second data corresponding to the cache read command. Then, the memory die 300 may perform a latching operation on the sensed second data.

When the memory die 300 performs the first and second cache read command operations, the operation of outputting the first data in response to the second cache read command and the operation of sensing the second data may be simultaneously performed. Consequently, when the memory die 300 performs a consecutive cache read command operation, read operation performance of the memory system 110 can be further improved that when the memory die 300 performs a consecutive normal read command operation.

The processor 134 may identify a memory die, in which data is stored in the memory device 150, based on a physical address. In order to improve the read operation performance of the memory system 110, depending on whether memory dies in which a plurality of read requests are to be processed are the same, the processor 134 may selectively generate normal read commands or cache read commands based on the read requests. For example, when a predictive read request is processed in a memory die the same as a memory die in which a preceding host read request is processed, the processor 134 may generate cache read commands corresponding to the host read request and the predictive read request. On the other hand, when a predictive read request is processed in a memory die different from a memory die in which a preceding host read request is processed, the processor 134 may control the memory device 150 to perform a read operation in an interleaved read manner in response to the predictive read request.

FIG. 8 is a timing diagram when a predictive read operation (“PREDICTIVE READ”) and a preceding host read operation (“HOST READ”) are performed using the cache read commands.

When the host read request and the predictive read request need to be processed in the same memory die, the processor 134 may generate a host cache read command corresponding to the host read request and a predictive cache read command corresponding to the predictive read request.

For example, both the host read request and the predictive read request may be processed in the first memory die DIE1. The processor 134 may sequentially provide the host cache read command and the predictive cache read command to the first memory die DIE1.

Referring to FIG. 8, the first memory die DIE1 may perform a sensing operation and a caching operation of a host data chunk in response to the host cache read command. The first memory die DIE1 may perform an output operation of the host data chunk in response to a subsequent predictive cache read command and simultaneously perform a sensing operation of a predicted data chunk. Then, the first memory die DIE1 may perform a caching operation of the sensed predicted data chunk to latch the predicted data chunk in a cache latch.

The first memory die DIE1 may prepare the predicted data chunk by latching the predicted data chunk in a page buffer in response to the predictive cache read command. An output operation of predicted data latched in the cache latch may be selectively performed. For example, when the predicted data is requested by the host 102, the processor 134 may provide a data output command to the first memory die DIE1 in response to the request. The first memory die DIE1 may perform the output operation of the predicted data in response to the data output command. The processor 134 may provide the host 102 with the predicted data output to the memory 144. On the other hand, when another command is received before the data output command is received, the first memory die DIE1 may remove the predicted data from the cache latch.

When using the cache read commands in order to acquire a host data chunk and a predicted data chunk included in the same memory die, the controller 130 may more quickly acquire the predicted data chunk than when using the normal read commands.

Meanwhile, as described with reference to FIG. 1, the memory device 150 may include a plurality of memory dies. The plurality of memory dies may perform a read operation in parallel in response to a read command. The processor 134 may interleave read commands for the plurality of memory dies. Interleaving the commands may refer to determining a command providing order such that the processor 134 may sequentially provide the commands to the plurality of DIEs.

FIG. 9 is a timing diagram when the predictive read operation (“PREDICTIVE READ”) and the preceding host read operation (“HOST READ”) are performed using the interleaved normal read commands.

The host read command may be executed in the first memory die DIE1 and the read command may be executed in the second memory die DIE2. The first memory die DIE1 and the second memory die DIE2 may sequentially receive the read commands through the first channel CH1. However, when the read command is received once, the first memory die DIE1 and the second memory die DIE2 may operate in parallel with each other.

When the host read request and the predictive read request need to be processed in different memory dies, the processor 134 may generate a host normal read command and a predictive normal read command corresponding to the host read request and the predictive read request, respectively. Then, the processor 134 may interleave the host normal read command and the predictive normal read command. The memory I/F 142 may sequentially provide the interleaved host read command and read command to the first memory die DIE1 and the second memory die DIE2.

The first memory die DIE1 may perform a sensing operation, a caching operation, and an output operation of a host data chunk in response to the host read command, and the second memory die DIE2 may perform a sensing operation, a caching operation, and an output operation of a predicted data chunk in response to the read command. The sensing operation, the caching operation, and the output operation have been described with reference to FIG. 7A.

The second memory die DIE2 may buffer a predicted data chunk in the memory 144 in response to the predictive normal read command, thereby preparing the predicted data chunk. When the predicted data chunk is requested by the host 102, the processor 134 may provide the host 102 with the predicted data chunk output to the memory 144. Meanwhile, when the predicted data is not requested by the host 102 until a predetermined condition is satisfied, the processor 134 may remove the predicted data chunk output to the memory 144.

Referring to FIG. 9, since respective operations of the host normal read command and the predictive normal read command may be simultaneously performed, the controller 130 may quickly acquire data predicted to be requested by the host 102.

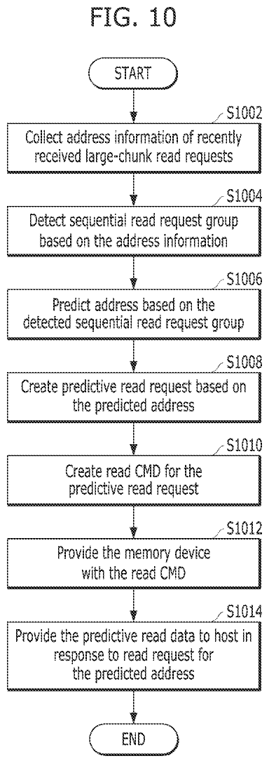

FIG. 10 is a flowchart describing an operation of the controller 130 in accordance with the embodiment of the present disclosure.

In operation S1002, the processor 134 may collect address information of large-chunk read requests recently received from the host 102.

For example, the large-chunk read requests may refer to read requests for data chunks having a predetermined size or more. That is, the processor 134 may collect only address information of read requests in which data length information is greater than a threshold value. Meanwhile, the address information may include logical address information.

In operation S1004, the processor 134 may detect a sequential read request group based on the logical address information.

For example, when it is detected that a predetermined or set number of addresses are consecutive in the collected address information, the processor 134 may determine that read requests corresponding to the consecutive addresses configure a sequential read request group associated with one data stream, thereby detecting the sequential read request group. Depending on implementation, the processor 134 may detect a sequential read request group by detecting consecutive addresses having the same length.

The processor 134 may assign a stream ID to the detected sequential read request group. The processor 134 may update the start address, the data length requested by each read request, and the last address for each stream ID in the stream table 600 described with reference to FIG. 6.

In operation S1006, the processor 134 may predict a logical address to be requested by the host 102, based on the detected sequential read request group.

For example, the processor 134 may predict an address of the data chunk, which is to be requested by the host 102, for each stream ID, based on the start address, the data length requested by each read request, and the last address for each stream ID in the stream table 600. Furthermore, the processor 134 may predict the data length of the data chunk, which is to be requested, based on the data length requested by each read request. The processor 134 may update the predicted address in the stream table 600.

In operation S1008, the processor 134 may generate a predictive read request for each stream ID based on the data length requested by each read request and the predicted address for each stream ID in the stream table 600.

In operation S1010, the processor 134 may generate a predictive read command corresponding to the predictive read request.

For example, the processor 134 may translate logical address information of corresponding read requests into physical address information in order to provide read commands to the memory device 150. Based on physical address information of the predictive read request and a preceding read request, the processor 134 may determine whether memory dies in which the predictive read request and a read request preceding to the predictive read request are to be processed are the same.

When the memory dies in which the predictive read request and the read request preceding to the predictive read request are to be processed are the same, the processor 134 may generate cache read commands corresponding to the predictive read request and the preceding read request.

When the memory dies in which the predictive read request and the preceding read request are to be processed are different from each other, the processor 134 may generate normal read commands corresponding to the predictive read request and the preceding read request and interleave the normal read commands.

In operation S1012, the processor 134 may provide the read command to the memory device 150 through the memory I/F 142.

In response to the read command, the memory device 150 may prepare in advance the predicted data chunk predicted to be requested by the host 102. For example, the memory device 150 may output the predicted data chunk to the memory 144 in response to the predictive normal read command. Then, the memory device 150 may latch the predicted data chunk in the cache latch in response to the predictive cache read command.

In operation S1014, the processor 134 may provide the prepared data chunk to the host 102 in response to an actual read request for the predicted data chunk with the predicted address from the host 102.

In accordance with an embodiment of the present disclosure, the controller 130 may detect at least one sequential read request group associated with at least one data stream based on address information of read commands, predict an address for each data stream, and control the memory device 150 to prepare the predicted address in advance. Even though the host 102 does not provide a stream ID to the controller 130, the controller 130 may perform a predictive read operation for each data stream, thereby improving the read operation performance of the memory system 110.

The present disclosure described above is not limited by the aforementioned embodiments and the accompanying drawings, and it is apparent to those skilled in the art to the present disclosure pertains that various substitutions, modifications, and changes can be made without departing from the technical spirit of the present disclosure.

What is claimed is:

1. A controller that controls a memory device, the controller comprising:
a processor configured to:
detect at least one sequential read request group corresponding to consecutive logical addresses among a predetermined number of host read requests, regardless of whether sequential read requests included in the sequential read request group are successively received,
predict logical addresses for the detected group of sequential read requests, and
control the memory device to prepare a data chunk associated with the predicted logical addresses; and
a memory configured to buffer the prepared data chunk,
wherein the processor is further configured to provide the buffered data chunk to a host when a request for the predicted data chunk is received from the host.

2. The controller of claim 1, wherein the processor predicts the logical addresses which is consecutive to the consecutive addresses.

3. The controller of claim 1, wherein the at least one sequential read request group is read requests, each of which have the same data length and which are consecutive by a predetermine length or more, among the host read requests.

4. The controller of claim 1, wherein the processor detects the at least one data stream by:
detecting sequential read request groups with a data length equal to or more than a threshold value among the host read requests and
detecting sequential read request groups corresponding to logical addresses consecutive to each other among the host read requests.

5. The controller of claim 1, wherein the processor is further configured to assign a stream ID to the detected sequential read request group.

6. The controller of claim 1,
wherein the logical addresses are used in the host, and
wherein the processor controls the memory device to prepare the data chunk associated with the logical addresses by:
generating a predictive read request corresponding to the logical addresses,
translating logical addresses of the predictive read request and a preceding read request preceding to the predictive read request into physical addresses associated with the memory device, and
generating a predictive read command corresponding to the predictive read request and a preceding read command corresponding to the preceding read request based on the physical addresses.

7. The controller of claim 6, wherein, when the physical addresses indicate the same memory die, the processor generates cache read commands as the predictive read command and the preceding read command.

8. The controller of claim 7, wherein the processor provides the buffered data chunk to the host by:
buffering, in the memory, the data chunk prepared in a page buffer of the memory device in response to the predictive read command, and
providing the buffered data chunk to the host in response to the request for the buffered data chunk.

9. The controller of claim 6, when the physical addresses indicate different memory dies, the processor generates normal read commands as the predictive read command and the preceding read command and interleaves the generated normal read commands.

10. The controller of claim 9, wherein the processor provides the buffered data chunk to the host by:
buffering, in the memory, the data chunk prepared in response to the predictive read command, and
providing the buffered data chunk to the host in response to the request for the prepared data chunk.

11. An operation method of a controller that controls a memory device, the operation method comprising:
detecting at least one sequential read request group corresponding to consecutive logical addresses among a predetermined number of host read requests, regardless of whether sequential read requests included in the sequential read request group are successively received;
predicting logical addresses for the detected group of sequential read requests;
controlling the memory device to prepare a data chunk associated with the predicted logical addresses; and
providing the prepared data chunk to the host when a request for the predicted data chunk is received from the host.

12. The operation method of claim 11, wherein the predicting of the logical addresses for the detected group of sequential read requests comprises predicting the logical addresses which is consecutive to the consecutive addresses.

13. The operation method of claim 11, wherein the at least sequential read request group is read requests, each of which has the same data length and which are consecutive by a predetermine length or more, among the host read requests.

14. The operation method of claim 11, wherein the detecting of the at least one data stream comprises:
detecting sequential read request groups with a data length equal to or more than a threshold value among the host read requests; and
detecting sequential read request groups corresponding to logical addresses consecutive to each other among the host read requests.

15. The operation method of claim 11, further comprising assigning a stream ID to the detected sequential read request group.

16. The operation method of claim 11,
wherein the logical addresses are used in the host, and
wherein the controlling of the memory device to prepare the data chunk associated with the logical addresses comprises:
generating a predictive read request corresponding to the logical addresses;
translating logical addresses of the predictive read request and a preceding read request preceding to the predictive read request into physical addresses associated with the memory device; and
generating a predictive read command corresponding to the predictive read request and a preceding read command corresponding to the preceding read request based on the physical addresses.

17. The operation method of claim 16, wherein the generating of the predictive read command and the preceding read command comprises generating cache read commands as the predictive read command and the preceding read command when the physical addresses indicate the same memory die.

18. The operation method of claim 17, wherein the providing of the prepared data chunk to the host comprises:
buffering, in a memory of the controller, the data chunk prepared in a page buffer of the memory device in response to the predictive read command; and
providing the buffered data chunk to the host in response to the request for the buffered data chunk.

19. The operation method of claim 16, wherein the generating of the predictive read command and the preceding read command comprises:
generating normal read commands as the predictive read command and the preceding read command when the physical addresses indicate different memory dies; and
interleaving the generated normal read commands.

20. The operation method of claim 19, wherein the providing of the prepared data chunk to the host comprises:
buffering, in a memory of the controller, the data chunk prepared in response to the predictive read command; and
providing the buffered data chunk to the host in response to the request for the prepared data chunk.
